(19) United States
(12) Patent Application Publication
(10) Pub. No.: US 2004/0153348 A1
(43) Pub. Date: Aug. 5, 2004

(54) Internet-based computer travel planning system

(76) Inventor: Brent J. Garback, Troy, MI (US)

Correspondence Address: WINSTON & STRAWN, PATENT DEPARTMENT, 1400 L STREET, N.W., WASHINGTON, DC, 20005-3502, US

(21) Appl. No.: 10/764,296

(22) Filed: Jan. 23, 2004

Related U.S. Application Data
(63) Continuation-in-part of application No. 10/246,878, filed on Sep. 19, 2002.
(60) Provisional application No. 60/323,350, filed on Sep. 19, 2001.

(51) Int. Cl. G06F 17/60

(52) U.S. Cl. 705/5

(57) ABSTRACT

A computer based system for processing travel requests directed to a specific venue from individual members of a sponsored group, such as a corporation or governmental entity. The system comprises a database containing a venue file including information regarding the specific venue, a group member file for each individual member of the group, a travel policy file containing information on preselected vendors of various travel services, and a city code file containing codes corresponding to a plurality of city airport locations. Data is entered and information displayed to an individual group member making a travel request, either for travel as an individual or as part of a group, via a terminal, such as a personal computer. A central processing unit is in communication with a plurality of travel booking websites via the Internet. The CPU is programmed to select an individual group member itinerary for the specific venue which includes specific airline flights, and if necessary, specific hotel accommodations and specific rental car services.

### CROSS-REFERENCE TO RELATED APPLICATIONS

This application is a continuation-in-part of U.S. patent application Ser. No. 10/246,878 filed Sep. 19, 2002, which claims priority from Provisional Application Serial No. 60/323,350 filed Sep. 19, 2001, the disclosures of each being incorporated by reference herein in its entirety.

### FIELD OF THE INVENTION

This invention relates generally to the field of computerized travel planning and booking systems and, more particularly to an Internet-based system for processing travel requests directed to a specific travel venue from individual members of a sponsored group.

### BACKGROUND OF THE INVENTION

Previously, most business travel arrangements were handled via telephone connection to either a travel agency, or in-house travel department, or directly by directly contacting a travel supplier such as an airline, hotel or car rental company. With the advent of the Internet, there are now numerous sites that provide travel information and pricing options. Consequently, business travelers and travel arrangers are able to make travel arrangements using any number of websites or reservation tools, in addition to the preferred travel agency or in-house travel department.

The data sources (availability and pricing) for travel arrangements were typically all provided by the Computer Reservation Systems (CRS), which include Sabre, Worldspan, Galileo, Amadeus, etc. These systems have become better known as GDS (Global Distribution Systems).

Most of these systems were previously owned by airlines and therefore were the principal data warehouse for all of the airfares that the airlines offered. However, because most of the airlines have sold their ownership in these systems and have moved to embrace the Internet to reduce their costs, these CRS/GDS systems no longer contain most of the airfares that the airlines may offer.

At the present time, many airlines still provide corporations, enterprises and organizations with special discounts that may be obtained through their travel agency or in-house travel department via the usage of a CRS/GDS. This practice may be changing as the mainline airlines consider even lower cost alternatives to distribute their inventory. Furthermore, new lost-cost airlines have emerged that avoid the CRS/GDS entirely and accept reservations only through their own websites.

These changes have precipitated the mainline airlines to rethink their distribution. As such these airlines now offer a variety of travel information, including inventory availability and pricing through their own websites. These websites may contain special pages list displays inventory and pricing that is only available for preferred business travelers; travelers participating in groups, meetings and events or for general travel usage. In fact, most airlines now have prerecorded announcements that warn travelers contacting their reservation centers (1-800-number) that lower airfares may be found at their website or at select other Internet sites.

These mainline airlines have decided to distribute their seat inventory through a variety of other websites. Some of the sites (such as Orbitz or Opodo) are jointly owned with other airlines. Still, other sites are operated by commercial services like Expedia, Travelocity and LowestFare.com, that may also offer hotels, car rental and other travel-related services.

As a result of the airlines restructuring with regard to the CRS/GDS as a principal means of distribution, it is not surprising that hotels and car rental companies have also decided to rethink their distribution strategy. Like the airlines, the hotel and car rental companies have begun to offer availability and special pricing through their own websites and those of other third party websites.

Therefore, the business traveler is potentially faced with any number of choices when making their travel arrangements. However, in many cases, these individuals are members of a sponsoring group (they are business travelers for a corporation, enterprise or organization) that has a travel policy and travel procedures that recommend or mandate the usage of particular options for those travel arrangements.

In many cases, the business traveler is a member of a group which is traveling to a specific venue. For example, the traveler may be attending a meeting, seminar or training program along with other individuals employed by the same corporation or other institution. In these cases, the sponsoring corporation or institution is generally expected to pick up the costs of this business travel. However, many sponsoring organizations have little control over the specific travel itineraries selected by those attending the meeting. For example, the individual traveler may select one airline over another on the basis of a frequent flier membership with that airline, rather than making a cost-effective decision. While businesses often have stated travel policies which require selection of the most cost-effective itinerary, such travel policies prove difficult to enforce in a climate where each individual traveler is left to make his/her own arrangements.

My own U.S. Pat. No. 5,237,499 (the disclosure of which is incorporated by reference herein) describes and claims a computer-based travel reservation system which may interact with CRSs such as Sabre and Worldspan to book airline reservations in accordance with preset travel policies established by a group such as an employer, as well as with a file of travel preferences corresponding to each member of the group.

Without a focal point, travelers and travel arrangers are apt to spend excessive amounts of time on the Internet in pursuit of wrong or inadequate information. Blindly using multiple sites and sources, individuals may eventually find “what they want”, but what they want and the time, it takes to find it can be extremely wasteful. Further, without being able to control the purchasing habits of their travelers and travel arrangers, these sponsoring organizations may ultimately lose their negotiated discounts and special group, meeting and event pricing.

Presently, there exists a need for an Internet-based travel planning system which can bypass the CRSs and allow an individual business traveler and member of a sponsoring group to effectively and efficiently book an itinerary for either a specified venue, such as an upcoming meeting or-seminar, or any business travel.

Thus, it is desirable that travelers and travel arrangers be provided with information that allows them to perform better, smarter and with less effort and that can help reduce travel costs for a sponsoring organization.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied and broadly described, the invention includes a method of managing travel within a sponsoring organization. The method includes receiving a travel request submitted for a group member of the sponsoring organization; identifying travel information from at least one vendor authorized by the sponsoring organization, wherein the travel information includes financial rates previously established between the vendor and the sponsoring organization; automatically comparing the identified travel information to alternative travel information, the alternative travel information including available financial rates offered through at least one alternative internet-based source; and selecting travel information from the comparing step for reservation for the group member. The method can further include reserving the travel itinerary over the internet.

In accordance with a further aspect of the invention, the method can include providing group member information, wherein the travel itinerary is constructed based at least in part on the group member information, which can be accessed from a database. The group member information can include information relating to at least one of the group member's (1) seating preference, (2) frequent flier information and (3) meal preference. Moreover, the group member information can be obtained from the website of the vendor.

In further accordance with the invention, the method can further include the step of providing a comparative analysis to the group member, where the comparative analysis identifies the alternative travel information identified by the comparing step.

The at least one vendor can provide services related to at least one of (1) airline services, (2) ground transportation and (3) room accommodation.

In accordance with still a further aspect of the invention, the travel itinerary can include airline services based on a previously established financial rate. Similarly, the travel itinerary can include ground transportation based on a previously established financial rate. The travel itinerary can additionally or alternatively include room accommodation based on a previously established financial rate.

In accordance with yet a further aspect of the invention, the method can also include providing venue information about a specific venue for which the group member is making travel arrangements. The venue information can include information relating to at least one of (1) a date on which an event begins, (2) a date on which an event ends and (3) the location of the event.

In accordance with another aspect of the invention, a system for managing travel within a sponsoring organization is provided. The system includes a computer configured to process a travel request inputted for a group member of the sponsoring organization; access a database containing identified travel information from at least one vendor authorized by the sponsoring organization in response to the inputted travel request, wherein the travel information includes financial rates previously established between the vendor and the sponsoring organization; compare the identified travel information to alternative travel information, the alternative travel information including available financial rates offered through an alternative internet-based source; select travel information based upon the comparison for reservation for the group member; and reserve a travel itinerary over the internet for the group member.

The system in accordance with the invention permits an individual business traveler to book an itinerary, including airline flights, hotel reservations and, if necessary, ground transportation, for a specific venue in a process that takes a relatively short period of time (e.g., thirty to forty seconds). The term “specific venue” refers to a particular travel destination, and can include airline flights, hotel accommodations and/or rental cars. The specific venue can be unique to the individual traveler on that particular occasion, can be a regularly traveled route for that traveler, or can also be a venue generally applicable to a group of members of the sponsoring organization if, for example, such a group is planning to attend a convention, meeting, conference, etc. In other words, the method and system of the present invention is particularly useful in the context of a managed travel program which uses preselected, preferred travel suppliers that are to be used in the exercise of all business travel for the members of the sponsoring group for a certain period of time (e.g., a year). Moreover, the itinerary so booked will automatically be in conformity with the fares prenegotiated by the sponsoring organization with various vendors.

To accomplish this, the present invention provides a database which contains a number of separate data files. One file, called a venue file, contains information about a specific venue for which individual travelers from the same sponsoring organization can make travel arrangements. The venue file can include, for example, information such as the date on which the travel begins, the date on which it ends, the city location of the travel destination, and the address location of the destination within the city. In cases where the sponsoring organization is sponsoring travel to a number of venues, a separate venue file may be provided for each such venue.

The database can further include a travel policy file which contains information on preselected airline carriers, preselected room accommodation providers, and preselected ground transportation providers. Normally, these vendors have been selected via negotiation with the sponsoring organization. Since the sponsoring organization can guarantee a certain number of travelers to the particular venue, it can usually negotiate group discounts on the airline flights, hotel rooms and car rental services. By negotiating with a plurality of vendors of each of these services, the group sponsor can obtain the most cost effective itinerary for that particular venue in terms of a specific airline carrier, hotel, and car rental company. The selections so made are all contained in the travel policy data file.

The database of the present system can further include a city code data file which contains codes corresponding to a plurality of city airport locations. This file makes it possible for the system to interface between the individual travel requests entered into the system (which are expressed in terms of departure city and destination city) and the various airline website inventories (wherein various airports are expressed in internationally recognized codes).

This city code data can be defined so that travelers will be automatically redirected to an alternative airport code in the event that a nearby airport could offer significant savings. Based upon negotiation, travelers requesting travel to, for example, Chicago O'Hare Airport could be redirected to Chicago Midway or travelers departing from Detroit Metropolitan Airport could be redirected to depart from Flint Bishop Airport. The system of the present invention automatically checks these alternative, nearby airports for possible cheaper fares.

A group member data file is provided for each individual member of the sponsoring organization. The group member file contains group member information (as described above) including, for example, personal data about the traveler and, optionally, preference information known about that group member, such as his/her preferences on airline seating, non-smoking arrangements, frequent flier membership, meal preferences, etc.

A ticketing file can be provided which contains reservations that must be ticketed in the future. The system can be configured to check the ticket file on a daily basis, and produce and route tickets and/or itinerary notices to the proper destination.

A user can communicate with the system of the present invention via a terminal, including means for entry of data corresponding to a particular group member's individual travel requests for a specific venue, such as a keypad or keyboard. Again, a specific venue may be defined as the destination of an individual traveler, or it could be a destination for a group of members of the sponsoring organization who are traveling together to a convention, conference, etc. The present system has the flexibility to establish travel policies to cover either type of situation or any combinations thereof. The terminal may be provided as part of the present system, or the system may alternatively operate on existing equipment. Typically, the terminal can be a personal computer which is in communication with the system of the present invention via a local area network, a wide area network, or the sponsoring organization's own information network. Typically, a sponsoring organization will be a private or public employer such as a corporation, government agency, etc., or any other type of organization whose members customarily travel, either on individual itineraries, or together on group itineraries. The display unit of the personal computer allows the user to both see and verify the information on his/her individual travel request that has been entered, and also to view the individual travel itinerary constructed for him/her.

In accordance with a further aspect of the invention, the computer can be further configured to display the travel itinerary on a display. The display can be a display device associated with a personal computer, a cell phone or a personal digital assistant.

In accordance with still a further aspect of the invention, the additional travel information can include rates that have not been previously established. In accordance with this aspect of the invention, the computer is configured to select the lower of the previously established financial rate and the non-previously established financial rate.

The system of the present invention also includes a central processing unit which is in communication with the database and with a plurality of travel planning websites via the Internet. The central processing unit is responsive to the individual travel request data entered on the terminal, and is programmed to emulate the decision making process of the typical corporate travel arranger. It retrieves information from the temporary individual travel request file, the specific venue file, the travel policy file including the prenegotiated vendors, and the group member file for the individual making the travel requests and, by accessing the flight schedules and other information contained in the travel planning websites, selects the optimum itinerary for that individual group member. The airline, hotel and ground transportation selections are then booked and displayed on the user terminal. Thus, rather than leaving it to the individual traveler, travel agent, or corporate travel arranger to process the myriad of data and arrive at the most cost-effective itinerary, the system automates that step of the process, and operates in a fraction of the time previously required to book a business reservation. Furthermore, it eliminates the possibility that the individual group member will circumvent the preferred travel vendors, thus significantly lowering the cost of corporate travel.

In accordance with another aspect of the invention, a machine readable program is provided containing instructions for controlling a device for managing travel within a sponsoring organization, comprising means for receiving a travel request submitted for a group member of the sponsoring organization; means for identifying travel information from at least one vendor authorized by the sponsoring organization, wherein the travel information includes financial rates previously established between the vendor and the sponsoring organization; means for automatically comparing the identified travel information to alternative travel information, the alternative travel information including available financial rates offered through at least one alternative internet-based source; and means for selecting travel information from the comparison for reservation for the group member. In accordance with this aspect of the invention, the program can be configured to automatically reserve a travel itinerary over the internet for the group member.

It is to be understood that both the foregoing general description and the following detailed description are exemplary and are intended to provide further explanation of the invention claimed.

### BRIEF DESCRIPTION OF THE DRAWINGS

The accompanying drawings, which are incorporated in and constitute part of this specification, are included to illustrate and provide a further understanding of the system, method and machine readable program of the invention. Together with the description, the drawings serve to explain the principles of the invention, wherein:

FIG. 1 is a schematic view of a system in accordance with the present invention;

FIGS. 2a through 2e represent various ports of a logical flow diagram showing the overall operation of the present invention;

FIG. 3 illustrates an embodiment of a travel request screen generated by the system of the present invention; and

FIG. 4 illustrates a typical itinerary display screen generated by the system of the present invention.

### DETAILED DESCRIPTION OF THE PREFERRED EMBODIMENTS

Reference will now be made in detail to the present preferred embodiments of the invention, an example of which is illustrated in the accompanying drawing. The method and corresponding steps of the invention and machine readable program will be described in conjunction with the detailed description of the system.

The methods and systems presented herein may be used for management of travel within a sponsoring organization. The present invention is particularly suited for minimizing travel costs for an organization by intelligently directing a group member of the sponsoring organization toward an optimum travel itinerary that can both maximize usage of specially negotiated rates between travel providers and the sponsoring organization, as well as determining the lowest cost alternative for a group member by directly communicating with the website of a travel service provider.

The present invention satisfies the need for an Internet-based travel planning system which can bypass the CRSs and allow an individual business traveler and member of a sponsoring group to effectively and efficiently book an itinerary for either a specified venue, such as an upcoming meeting or seminar, or any business travel by directly interacting with the computer inventories of individual airlines' websites. The term “sponsoring group” refers to such entities as employers or organizations who have established a set of travel policies for their members, and also may have negotiated favorable rates with airlines, hotel chains, car rental agencies, etc. The present invention also satisfies the need for such a system which allows such a traveler to book an itinerary only if it conforms with a preset travel policy prenegotiated by the traveler's sponsoring organization. The present invention satisfies these needs by providing an “intelligent switch” to meaningfully direct travelers and travel arrangers based on all available information so that they can make correct decisions for themselves and the organization as they process their travel arrangements.

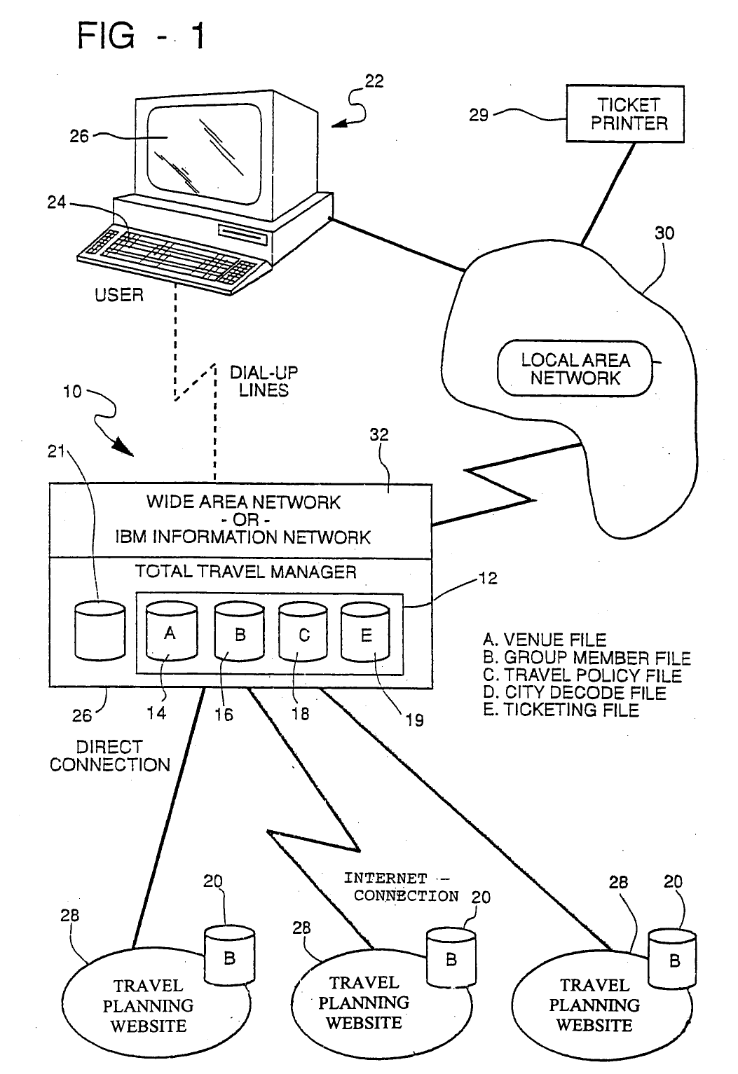

Throughout the following detailed description, like reference numerals are used to refer to the same element of the invention shown in multiple figures thereof. Referring now to the drawings, and in particular to FIG. 1, there is shown an Internet-based travel planning system 10 of the present invention which includes a database 12 containing at least one venue file 14, a travel policy file 16, and a city decode file 18. The venue file 14 includes information regarding a particular travel venue for which travelers who are members of a particular organization will need travel arrangements. For example, the venue will be a meeting, a seminar, a convention, a training program, etc. which a group of members of the sponsoring organization, such as a corporation, educational institution, non-profit foundation, etc., will be attending, with the sponsoring organization paying for the travel expenses incurred by the group members. However, the venue could be of another forum, such as a subsidiary location or field location of a corporation, to and from which a significant number of corporate employees regularly travel as individuals or in small groups. Since the cost effectiveness of the system of the present invention is realized largely through savings realized by negotiating group discounts with preselected vendors of airline, hotel and rental car services, any situation where enough members of the sponsoring organization make travel arrangements to the same location may be denominated a venue for purposes of this invention. A venue file 14 for each such venue is located in the database 12. The term “group discounts” includes business, organizational and government volume discounts that have been negotiated, usually in a one-year or multi-year contract. Heavy travel on certain venues either by the accumulation of individuals traveling on different occasions, or by groups traveling together to attend conferences, etc., make possible these group discounts.

The travel policy file 16 includes information regarding the preselected vendors negotiated by the sponsoring organization. Typically, a representative from the sponsoring organization will negotiate with various airline carriers, hotels, and rental car companies for group travel discounts for a specific venue. For example, if the sponsoring organization is headquartered in Philadelphia and has numerous clients in New York City, then individual members of the organization may make frequent trips from Philadelphia to New York City. This heavy volume of travel makes possible the negotiation of a travel discount for members of the organization who travel on this itinerary. Alternatively, the sponsoring organization may be able to achieve a group discount because many members of the organization will be traveling together to a particular destination. Those vendors making the lowest bids on these services will then be denominated preselected vendors, and will be included in the travel policy file 16. Thus, if an upcoming meeting is to be held in Rockefeller Center in New York City, beginning on September the 13th and ending on September the 16th, the travel policy file 16 will include one or more preselected airline carriers, covering travel from different parts of the country, to New York City on those dates. One or more hotel vendors will be designated as preselected, as will one or more car rental companies, if ground transportation is deemed necessary. Of course, travel to New York City on a variety of dates for individual members of the organization can also be part of the bidding process and be included in the travel policy file. For example, all individual travelers from a corporation, organization or government entity who travel to New York City individually must use a pre-negotiated set of particular travel suppliers (airlines, hotels and car rentals) to conform and comply with the organization's travel policy.

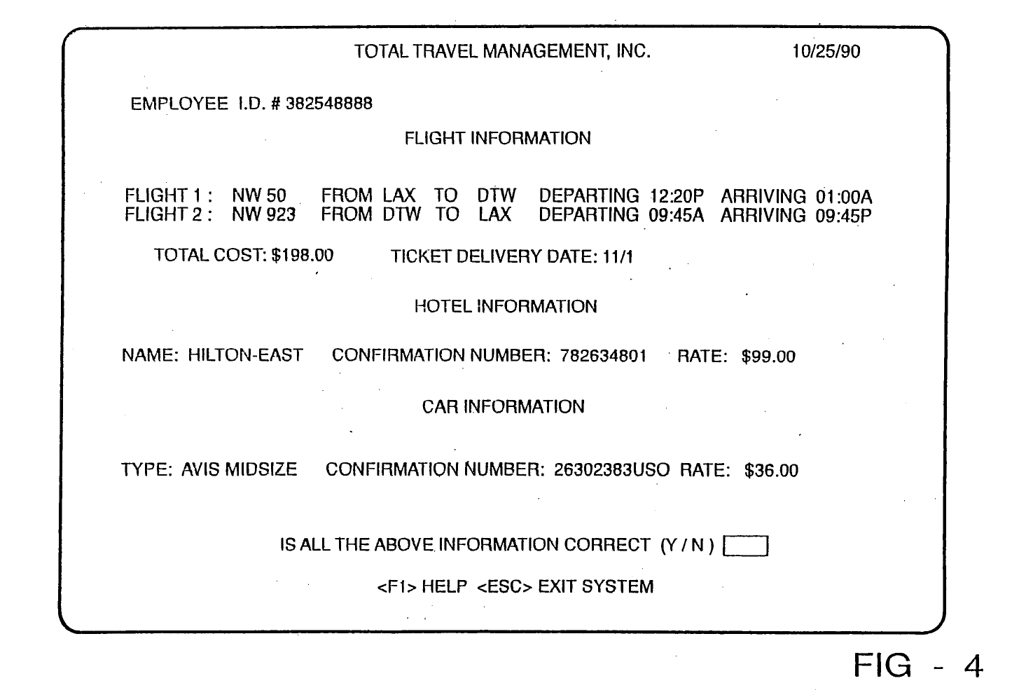

The city decode file 18 simply includes a list of internationally recognized codes for airports located in cities throughout the United States. The purpose of city decode file 18 is to permit departure and destination city information entered on travel request screen 71, (see FIG. 3) to be translated into the city codes recognized by the various airline website inventories 28. The system may be programmed to search as well for lower fares using preselected airports nearby the target departure or arrival airport. Individual group member files 20 are also provided which, in the embodiment shown in FIG. 1, are located within the databases 28 of the individual airline website inventories. However, it is contemplated that passenger files 20 could also be resident in database 12.

A terminal 22 permits the individual group member to enter his/her travel requests on a data entry means, such as keyboard 24, and also to view travel information provided by the system of the present invention via a display means such as screen 26. Terminal 22 may be a dedicated terminal or it may be existing equipment. Terminal 22 may also be an individual cell phone, a PDA (personal digital assistant), a voice recognition system, or any other way of inputting individual data into the system. Since terminal 22 includes both data entry means and display means, the individual group member can interactively interrogate the system.

In one embodiment of the present invention, the terminal 22 comprises a personal computer with a modem and suitable communications software so that the individual group member may access the system 10 via telephone lines, either through a local area network 30, or, alternatively, through a wide area network 32 or an information network provided by the sponsoring organization. In this embodiment, the system may further include suitable software for the personal computer which initially, and independently of accessing the system 10 itself, can display a format screen 71, such as that illustrated in FIG. 4, with blanks to permit entry of various travel data, as will be explained subsequently in greater detail, and to store the data inputted in a temporary file which can be sent to the central system. However, in an alternative embodiment, these functions can also be performed by the central system 10, itself. The system 10 further includes a central processing unit 26 which is in communication with the database 12, and is also in communication with a plurality of travel planning websites 28 via the Internet. The central processing unit 32 is responsive to the individual travel requests data entered on terminal 22 and is programmed to select an individual group member itinerary for a specific venue in response to an individual travel request from a group member. The individual group member itinerary includes, at a minimum, specific airline flights, and may also include specific hotel accommodations and specific ground transportation services. The central processing unit is further programmed to display the selected flights, hotel accommodations and ground transportation services to the individual group member (individual member of a group such as a business or governmental entity who must comply with the organization's travel policy) via the display means of the terminal 22. Since the central processing unit is in communication with travel planning websites, it also performs the function of booking the selected itinerary.

In a particularly preferred embodiment of the system of the present invention, the central processing unit is further programmed to make a price comparison between the negotiated fares available from the preselected vendors and any other airline flight for the same venue available from the airline inventories 28. In this embodiment, the system 10 initially selects an itinerary based on the negotiated fares from the preselected vendors contained in the travel policy file 18. An itinerary is then booked which relies on the preselected vendors. The system 10 then performs a price check by further interrogating the travel planning websites 28 to discover whether there are any lower published fares available for the same venue. If lower fares are discovered, the system 10 may cancel the original bookings and rebook the itinerary by using the lower published fares.

In either embodiment, once a firm booking is made, an e-ticket typically will be created which will be displayed on the display means. The traveler may print the e-ticket on printer 29.

As shown in FIG. 3, the individual group member initiates the process by filling out a screen 71 which will format an electronic travel request. The screen 71 includes an employee identification code window 72, an individual venue or meeting code window 73, departure and destination city windows 74, 77, departure and return date and time windows 75, 76, 78, 79, a hotel request window 80, a car rental request window 81, special request windows 82, 83, a ticket delivery date window 84 and a verification window 85. Additional pop up menus (not illustrated) are available to assist the user with decoding city and airport names, and selecting preferred hotel and car vendors. When the user confirms that the information entered is correct via window 85, the travel request is formatted in a delimited file and sent to the central system 10.

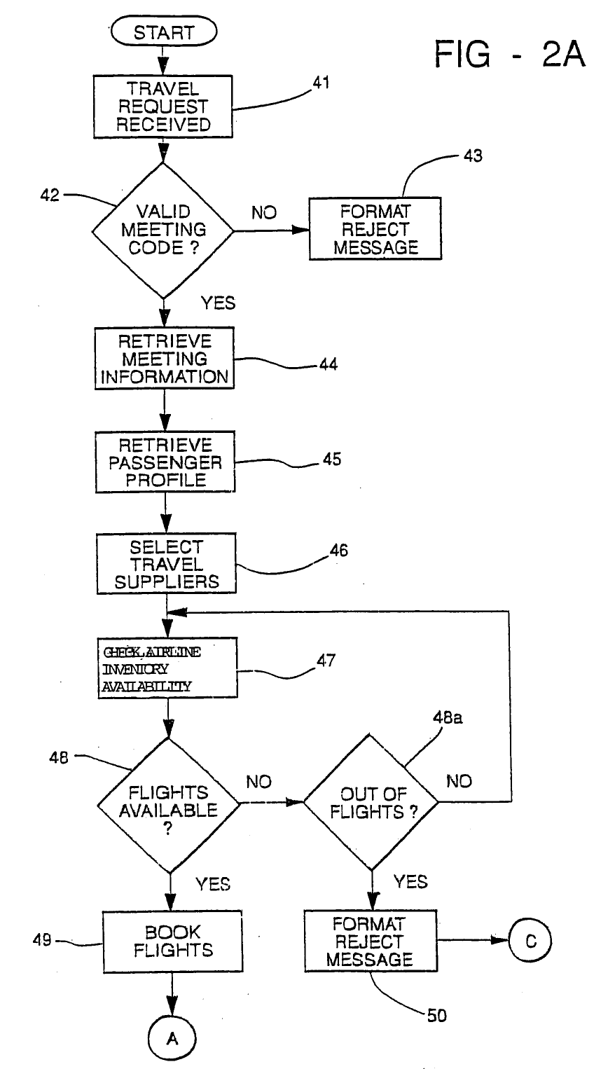

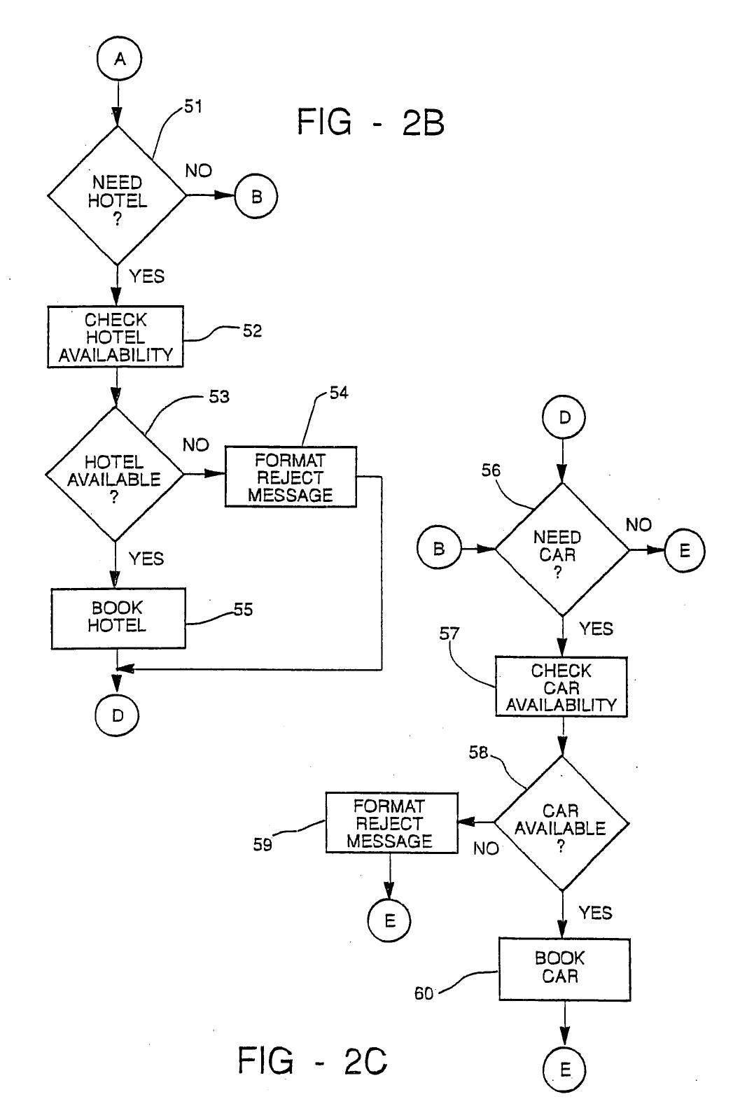

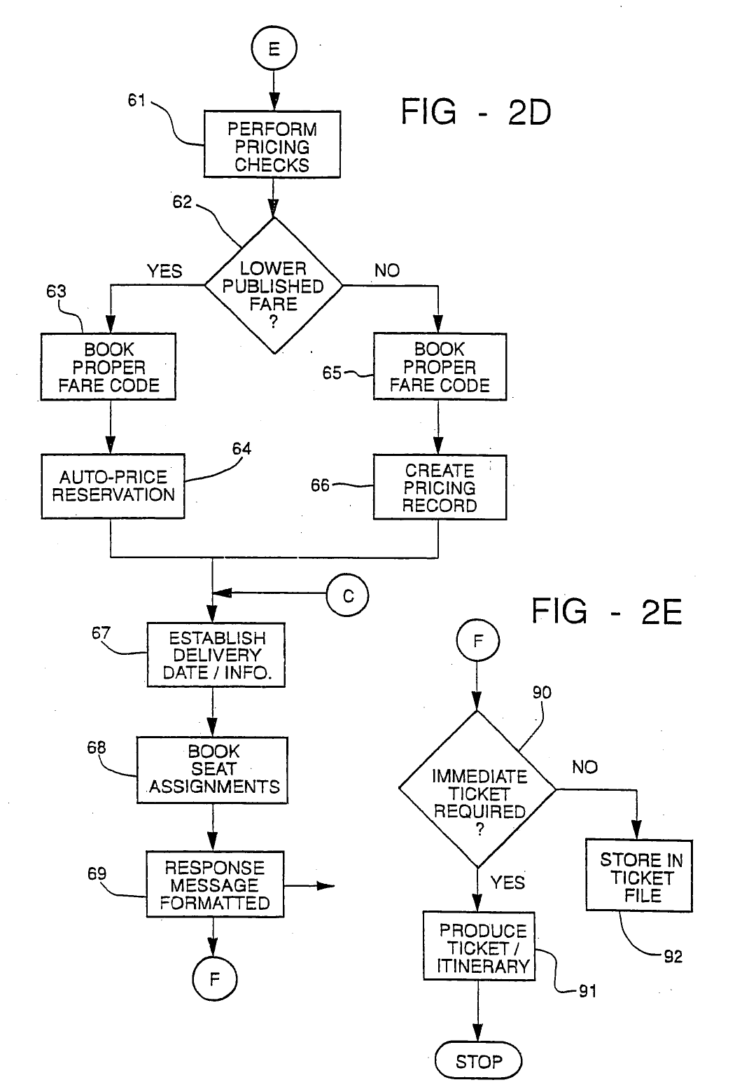

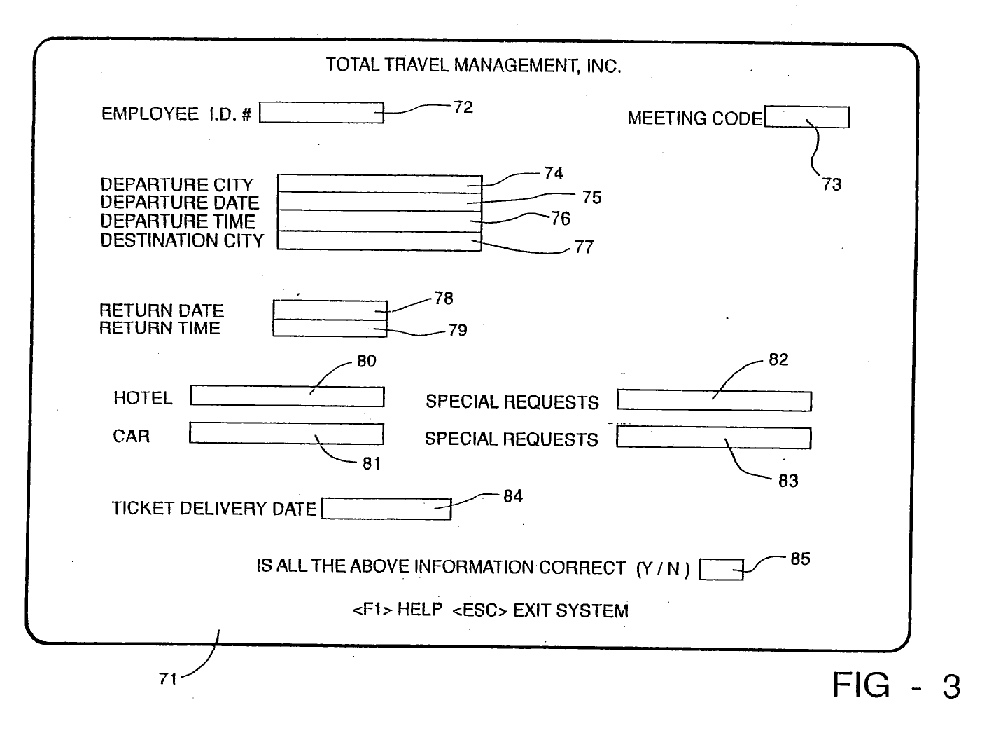

FIGS. 2a-2d are flowcharts which show the step-by-step operation of the system of the present invention. As shown in FIG. 2a, the initial travel request data is received in step 41 and is checked for a valid venue code in step 42. If an invalid venue code is encountered, an error message is formatted in step 43 and returned to the individual group member. If a valid venue code is encountered, the venue criteria with respect to dates, place, etc. is retrieved from the venue file 14 in step 44. To assist with the booking process, passenger information is retrieved from the group member file 20 in step 45, and information such as form of payment, or special service requests are moved into a shell reservation created on the travel planning website 28. Using the information retrieved from the venue file 14 and the group member file 20, the airline, hotel and ground transportation vendors are selected in step 46.

An airline availability request is formatted based upon the time and date of travel requested (the request can be based upon departure or arrival time) and the travel planning website 28 is interrogated in step 47. The sponsoring organization, however, may have implemented travel policies which change, direct or modify the traveler's request to search a particular airline (such as a low cost carrier) as well as a nearby airport which may offer a lower cost fare. Once a response is received from the website 28, the response is read and the appropriate flights are selected. If the selected flights are available, the system moves to block 48, and a booking request is formatted and sent to the website 28 in step 49. If the flights are not available, the system 10 will continue to interrogate a travel planning website 28 until an available flight is located in step 48a. If available flights cannot be located, an error message is formatted in step 50 and returned to the originator.

Once appropriate flights have been selected that are consistent with the sponsoring group's preselected and preferred travel suppliers and/or travel policies and procedures, a determination is made whether a hotel is required in step 51 (See FIG. 2b). If a hotel is not required, the hotel selection module shown in FIG. 2b is bypassed. If one is required, a hotel availability request is formatted in step 52 and sent to the website 28. Once a response is received from the website 28, it is read, and if the hotel is available, as block 53 indicates, a booking request is formatted in step 55 and sent to the website 28. If the hotel is not available, a reject message is formatted in step 54, and program control passes to the car booking module.

The car booking module is illustrated in FIG. 2c. If a car is required, as is indicated by block 56, a car availability request is formatted in step 57 and sent to the website 28. Once a response is received from the website 28, it is read, and if the car is available, as is indicated in block 58, a booking request is formatted and sent to the website 28 in step 60. If the car is not available, a reject message is formatted in step 59, and program control passes to the pricing module shown in FIG. 2d.

The travel policy file 18 and the various website 28 tariff displays are interrogated for applicable fares for the airline itinerary in step 61 (See FIG. 2d). If, in step 62, a published fare is located on an airline website 28 which is lower than the negotiated fare from the travel policy file 18, a cancel and rebook message may be formatted and sent to the website 28 in step 63 for the applicable booking code for the fare. Once the confirmation response is received from the website 28, an auto pricing request is formatted and sent to the website 28 in step 64. If, on the other hand, a lower published fare is not located, a cancel and rebook message is formatted and sent to the website 28 for the applicable prenegotiated booking code in step 65. Once the confirmation response is received, a manual pricing record request is formatted and sent to the website 28 in step 66.

Based upon the travel request and the ticketing date for the fare, a ticketing and delivery date is established in step 67, or the ticketing may be done electronically and printed up by the traveler. A request is formatted for the website 28 to store the delivery information in the reservation. A seat assignment request is formatted and sent to the website in step 68.

A response message, such as is illustrated in FIG. 4, is formatted in step 69 to be returned to the individual group member traveler. Preferably, delivery of the itinerary is by means of electronic transmission. The response message includes flight information, hotel information, car information, seat assignments and delivery information.

FIG. 2e illustrates the ticketing module of the present invention. If a ticket is required immediately (step 90), a ticket may be issued electronically and transmitted to the traveler via e-mail for subsequent printing. The print message enables printer 29 to print an airline ticket and an invoice/itinerary. If an immediate ticket is not required, control passes to block 92 which sends a confirmation message to the ticketing file 19. Ticketing file 19 holds the message until the day of ticketing. The CPU 32 is programmed to check ticketing file 19 daily for such messages.

The travel planning system of the present invention has been illustrated with reference to various embodiments and exemplifications thereof. By using the teachings of the present invention, doubtless one skilled in the art may be able to design other versions of the system which differ from those illustrated. However, the present invention is not intended to be limited by the embodiments and exemplifications illustrated and described. Rather, it is the claims appended thereto and all equivalents thereof which define the scope of the present invention.

What is claimed is:

1. A method of managing travel within a sponsoring organization, comprising:
receiving a travel request submitted for a group member of the sponsoring organization;
identifying travel information from at least one vendor authorized by the sponsoring organization, wherein the travel information includes financial rates previously established between the vendor and the sponsoring organization;
automatically comparing the identified travel information to alternative travel information, the alternative travel information including available financial rates offered through at least one alternative internet-based source; and
selecting travel information from the comparing step for reservation for the group member.

2. The method of claim 1, further including the step of providing group member information, wherein the travel itinerary is constructed based at least in part on the group member information.

3. The method of claim 2, wherein the group member information includes information relating to at least one of the group member's (1) seating preference, (2) frequent flier information and (3) meal preference.

4. The method of claim 2, wherein the group member information is obtained from the website of the vendor.

5. The method of claim 1, further comprising the step of providing a comparative analysis to the group member, the comparative analysis identifying the alternative travel information identified by the comparing step.

6. The method of claim 5, wherein the at least one vendor provides services related to at least one of (1) airline services, (2) ground transportation and (3) room accommodation.

7. The method of claim 6, wherein the travel itinerary includes airline services based on a previously established financial rate.

8. The method of claim 7, wherein the travel itinerary includes ground transportation based on a previously established financial rate.

9. The method of claim 8, wherein the travel itinerary includes room accommodation based on a previously established financial rate.

10. The method of claim 1, further comprising the step of reserving the travel itinerary over the internet.

11. The method of claim 1, further including the step of providing venue information about a specific venue for which the group member is making travel arrangements.

12. The method of claim 9, wherein the venue information includes information relating to at least one of (1) a date on which an event begins, (2) a date on which an event ends and (3) the location of the event.

13. A system for managing travel within a sponsoring organization, comprising a computer configured to:
process a travel request inputted for a group member of the sponsoring organization;
access a database containing identified travel information from at least one vendor authorized by the sponsoring organization in response to the inputted travel request, wherein the travel information includes financial rates previously established between the vendor and the sponsoring organization;
compare the identified travel information to alternative travel information, the alternative travel information including available financial rates offered through an alternative internet-based source;
select travel information based upon the comparison for reservation for the group member; and
reserve a travel itinerary over the internet for the group member.

14. The system of claim 13, wherein the computer is further configured to display the travel itinerary on a display.

15. The system of claim 14, wherein the display is selected from the group consisting of (1) a personal computer, (2) a cell phone and (3) a personal digital assistant.

16. The system of claim 13, wherein the additional travel information includes rates that have not been previously established.

17. The system of claim 16 wherein the computer is configured to select the lower of the previously established financial rate and the non-previously established financial rate.

18. The system of claim 13, wherein the group member information is accessed from the database.

19. A machine readable program containing instructions for controlling a device for managing travel within a sponsoring organization, comprising:
means for receiving a travel request submitted for a group member of the sponsoring organization;
means for identifying travel information from at least one vendor authorized by the sponsoring organization, wherein the travel information includes financial rates previously established between the vendor and the sponsoring organization;
means for automatically comparing the identified travel information to alternative travel information, the alternative travel information including available financial rates offered through at least one alternative internet-based source; and
means for selecting travel information from the comparison for reservation for the group member.

20. The machine readable program of 19, wherein the program is configured to automatically reserve a travel itinerary over the internet for the group member.
